(19) United States
(12) Patent Application Publication
(10) Pub. No.: US 2024/0232912 A9
(43) Pub. Date: Jul. 11, 2024

(54) KNOWLEDGE GRAPH IMPLEMENTATION

(71) Applicant: MasterControl Solutions, Inc., Salt Lake City, UT (US)

(72) Inventors: Alexander Kaplunov, Salt Lake City, UT (US); Viktoria Borisovna Rojkova, Salt Lake City, UT (US); Susan Melinda Marchant, Salt Lake City, UT (US); Dawn Marie Irons, Salt Lake City, UT (US); Erin Marie Wright, Salt Lake City, UT (US); Patricia Santos-Serrao, Salt Lake City, UT (US)

(21) Appl. No.: 18/489,756

(22) Filed: Oct. 18, 2023

Related U.S. Application Data
(60) Provisional application No. 63/418,423, filed on Oct. 21, 2022.

(51) Int. Cl. G06Q 30/018; G06N 5/022

(52) U.S. Cl. CPC G06Q 30/018; G06N 5/022

(57) ABSTRACT

A computer system for implementing a knowledge graph includes one or more processors and one or more computer-readable media having executable instructions stored thereon. The executable instruction, when executed by the one or more processors, configure the computer system to receive a digital file including a compliance file, which includes one or more levels of compliance processes in a hierarchical order, generate a knowledge graph from text within the digital file, receive a query regarding compliance to the digital file, calculate a metric between each node to a query vector of the query, and provide one more compliance paths to one or more target nodes based on metrics. The knowledge graph is generated by creating nodes based on one or more text entities within the digital file, creating edges based on relationships between the nodes within the digital file, and generating the knowledge graph based on the nodes and the edges.

### CROSS-REFERENCE TO RELATED APPLICATIONS

This application claims the benefit of U.S. Provisional Application Ser. No. 63/418,423, filed Oct. 21, 2022, of which entire content is hereby incorporated by reference as though fully set forth herein.

### FIELD OF THE INVENTION

The present application relates to computer systems, methods, and computer readable media generally for generating a knowledge graph and particularly for generating one or more knowledge graphs based on a corpus of text documents to find an optimum route to arrive at a target node.

### BACKGROUND

Computers and computing systems have affected nearly every aspect of modern living. Computers are generally involved in work, recreation, healthcare, transportation, entertainment, household management, legal compliances, etc. The ability of computers to store and analyze large data sets has provided unique insights into underlying correlations. In addition to providing unique insights into the large datasets, computers are also able to perform various actions or respond to user actions based upon the information in the dataset.

One area of particular interest and use in data analysis is knowledge graphs. Generally, knowledge graphs comprise information that has been linked together using a structured semantic topology. These structured relationships can be used to generate unique insights and to provide unique information derived from large datasets.

The subject matter claimed herein is not limited to aspects that solve any disadvantages or that operate only in environments such as those described above. Rather, this background is only provided to illustrate one exemplary technology area where some aspects described herein may be practiced.

### BRIEF SUMMARY

Disclosed aspects include a computer system for implementing a knowledge graph. The computer system includes one or more processors and one or more computer-readable media having executable instructions stored thereon. The executable instruction, when executed by the one or more processors, configure the computer system to receive a digital file including a compliance file, which includes one or more levels of compliance processes in a hierarchical order, generate a knowledge graph from text within the digital file, receive a query regarding compliance to the digital file, calculate a metric between each node to a query vector of the query, and provide one more compliance paths to one or more target nodes based on metrics. The knowledge graph is generated by creating nodes based on one or more text entities within the digital file, creating edges based on relationships between the nodes within the digital file, and generating the knowledge graph based on the nodes and the edges.

Disclosed aspects also include a method implementing a knowledge graph. The method includes receiving a digital file including a compliance file, which includes one or more levels of compliance processes in a hierarchical order, generating a knowledge graph from text within the digital file, creating nodes based on one or more text entities within the digital file, creating edges based on relationships between the nodes within the digital file, and generating the knowledge graph based on the nodes and the edges, receiving a query regarding compliance to the digital file, calculating a metric between each node to a query vector of the query, and providing one more compliance paths to one or more target nodes based on metrics. The knowledge graph is generated by creating nodes based on one or more text entities within the digital file, creating edges based on relationships between the nodes within the digital file, and generating the knowledge graph based on the nodes and the edges.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific aspects which are illustrated in the appended drawings. Understanding that these drawings depict only typical aspects and are not therefore to be considered to be limiting in scope, aspects will be described and explained with additional specificity and detail through the use of the accompanying drawings.

FIG. 1 illustrates a schematic diagram of a computer system for implementing a dynamic compliance knowledge graph according to various aspects of the present disclosure.

FIG. 2 illustrates a functional flow diagram of a system for implementing a dynamic compliance knowledge graph according to various aspects of the present disclosure.

FIG. 3A illustrates an example table of content of one section of the Code of Federal Regulations.

FIG. 3B illustrates representations of nodes of a knowledge graph after processing portions of the Code of Federal Regulations according to various aspects of the present disclosure.

FIG. 4 illustrates a simplified knowledge graph of the Code of Federal Regulations according to various aspects of the present disclosure.

FIG. 5A illustrates a simplified dynamic compliance knowledge graph with two potential compliance paths according to various aspects of the present disclosure.

FIG. 5B illustrates a simplified dynamic compliance knowledge graph with one compliance path according to various aspects of the present disclosure.

FIG. 6 illustrates a flowchart of steps of a method for implementing a dynamic compliance knowledge graph according to various aspects of the present disclosure.

### DETAILED DESCRIPTION

Disclosed aspects include systems, methods, and computer readable media that are configured to generate a dynamic compliance knowledge graph. As used herein, a “dynamic compliance knowledge graph” comprises a knowledge graph that is built based upon one or more data sources of compliance information. Further, a dynamic compliance knowledge graph provides functionality to map a user's current status to the dynamic compliance knowledge graph and to provide users with a metric indicating the user's level of compliance with regulatory laws and codes.

For example, a user may be a manufacturer of pharmaceutical goods or drugs. Within the United States, manufacturing of pharmaceuticals is heavily regulated by statutes, federal regulations, and various other governmental entities. Due to the complexity in interactions and relationships among the statutes, federal regulations, and various requirements by related governmental entities, it is quite difficult and cumbersome to find the best practice to comply with various requirements of the statutes, federal regulations, and related governmental entities.

Further, the statutes, federal regulations, and requirements of the related governmental entities are constantly changing to reflect current and updated circumstances and accommodate current and updated needs of the society and people. Such constant changes make compliance more complicated and complex.

Furthermore, due to the complexity in compliance, substantial amounts of money is needed to comply with all the requirements. In cases when incorrect statutes, federal regulations, or requirements are followed, the cost of non-compliance may lead to the loss of a business. Even when following all the requirements, due to the constant changes, what was once compliance may turn out to be non-compliant. Thus, total operating cost of staying compliant constantly adds up.

In this regard, compliance is not just data and information challenges but is a knowledge challenge, meaning that integration of the statutes, federal regulations, and requirements of the related governmental entities is essential to be compliant. The integration includes making associations among the statutes, federal regulations, and requirements of the related governmental entities and finding the most proper portions from the statutes, federal regulations, and requirements of the related governmental entities to be compliant. Thus, knowledge of them becomes a highly valuable assets of business entities (e.g., manufacturers of pharmaceuticals, goods, skin care, drug, toys, hygiene products, kitchen essentials, home appliances, electronics, etc., builders of residential homes or business establishments, financial companies, restaurant owners, management companies, distributors, importers, exporters, etc.), which need to follow statutes, regulations, and/or requirements by governmental or civil agencies.

Using disclosed methods, systems, and apparatus provided herein, a dynamic compliance knowledge graph is generated using the various statutes, federal regulations, and requirements by various governmental and civil agencies. Users are then able to provide a current status of the user's manufacturing process to the knowledge graph. For example, the user may provide data indicating that the user had installed specific hardware and software and that the user has provided specific sets of information to a regulating body.

In response, the dynamic compliance knowledge graph maps the user's current manufacturing status to the dynamic compliance knowledge graph. Such a mapping may include the dynamic compliance knowledge graph mapping the user's current manufacturing status to multiple different regulations, statutes, and/or requirements.

Knowledge graphs in this disclosure may be a dynamic and flexible collection of interlinked descriptions of real-world facts and concepts such as people, places, and events, legal or regulatory requirements, etc. The knowledge graphs may include one or more nodes and one or more edges, each of which connects two nodes. For example, nodes may represent descriptions of real-world facts and concepts such as people, places, and events, legal or regulatory requirements, etc., and edges may represent relationships or associations among the nodes of descriptions of real-world facts and concepts. The relationship or association may be made based on semantic relationships.

By leveraging semantic relationships created within the dynamic compliance knowledge graph, the dynamic compliance knowledge graph may be traversed starting from the nodes that were mapped to the user's current manufacturing status. The dynamic compliance knowledge graph may also be traversed from the mapped nodes to a desired outcome from the regulations, statutes, and/or requirements. In at least one aspect, the dynamic compliance knowledge graph provides a user with multiple potential pathways to be compliant based upon the user's current manufacturing status.

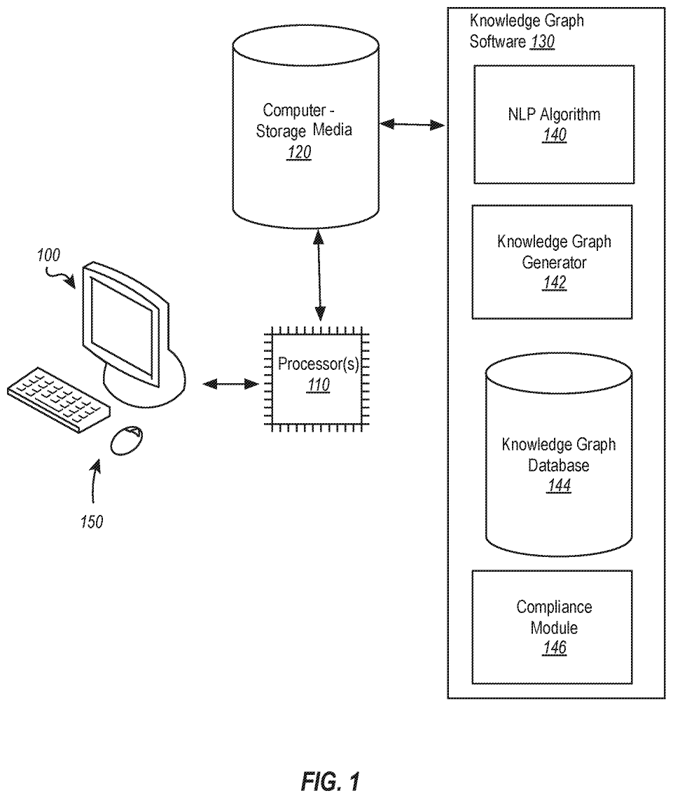

FIG. 1 illustrates a schematic diagram of a computer system 100 for generating a dynamic compliance knowledge graph. The computer system 100 may include one or more processors 110 and computer-storage media 120. As used herein, “computer-storage media” comprises physical non-transitory media. The one or more processors 110 and the computer-storage media 120 store and execute a dynamic compliance knowledge graph software application 130. The dynamic compliance knowledge graph software application 130 may include a natural-language processing (NLP) algorithm 140. The NLP algorithm 140 may include lemmatization and stemming, topic modelling, keyword extraction, knowledge graphs, word clouds, name entity recognition, text summarization, bag of words, tokenization, or any other NLP algorithm. Further, the NLP algorithm may comprise an NLP engine provided by a third party, such as Google™.

Additionally, the dynamic compliance knowledge graph software application 130 may include a knowledge graph generator 142 that creates the dynamic compliance knowledge graph. The dynamic compliance knowledge graph software application 130 may also include a knowledge graph database 144 that stores the resulting dynamic compliance knowledge graph. The knowledge graph database 144 may include any form of storage capable of storing digital data, including but not limited to, a hard drive, a solid status drive, RAM, etc.

The dynamic compliance knowledge graph software application 130 may further include a manufacturing compliance module 146. The manufacturing compliance module 146 may include a machine learning algorithm, a search algorithm, and/or some other algorithm that can traverse the dynamic compliance knowledge graph. The manufacturing compliance module 146 is configured to receive information about a current status of a manufacturing process, map the information to one or more current nodes within the dynamic compliance knowledge graph, and determine a metric to indicate a distance between the one or more current nodes to one or more target nodes. As used herein, current nodes include nodes in the dynamic compliance knowledge graph that describe a current status of the user in the manufacturing process. Additionally, as used herein, target nodes include one or more nodes within the dynamic compliance knowledge graph that represent the desired compliance process and/or the user provided target status in the compliance process.

In at least one aspect, the computer-storage media 120 may include processor-executable instructions stored thereon that, when executed by the one or more processors 110, cause or configure the computer system 100 to perform various tasks. For example, the computer system 100 can receive a digital compliance file. The digital compliance file includes regulations or statutes governing one or more compliance processes for manufacturing specific items. For example, the digital compliance file may include the Code of Federal Regulations, the United States Code, requirements provided by governmental or civil agencies, manufacturer specific guidelines, or any other text-based data set of information relating to the compliant manufacturing of products.

The computer system 100 may then generate a knowledge graph from a corpus of text within the digital compliance file. In at least one aspect, the computer system 100 may generate the knowledge graph by 1) creating nodes that represent one or more text entities within the digital compliance file, 2) identifying relationships between the nodes within the digital compliance file, and 3) building ontological relationships (e.g., the edges) between the nodes. The knowledge graph may be created based on the nodes and edges.

Each node of the knowledge graph may include metadata, which has textual information and hierarchical information of the node within the digital compliance file. The hierarchical information may indicate which title, chapter, subchapter, section, SubSection, and/or part the node is located within the digital compliance file. Also, each node may be represented as a vector so that a metric (e.g., distance) between two nodes may be calculated to compare how close two nodes are. The smaller the metric is, the closer the two nodes are. In an aspect, the metric may be based on semantic similarity. Thus, the metric provides a higher value when two nodes are similar than when two nodes are not similar. In this instance, the higher the metric is, the closer the two nodes are.

The computer system 100 may utilize the NLP algorithm 140 to process the information within the digital compliance file. The NLP algorithm 140 may process the words and phrases within the digital compliance file and identify relationships between different portions of the digital compliance file. For example, the NLP algorithm 140 may process a portion of the digital compliance file that states requirements for various stages of a compliance process. The NLP algorithm 140 may then identify within the digital compliance file definitions of the various stages of the compliance process and/or definitions of the requirements for each stage.

Using the output of the NLP algorithm 140, the knowledge graph generator 142 may be able to create nodes from the various terms and/or phrases identified by the NLP algorithm 140. The knowledge graph generator 142 may connect the nodes with edges that define ontological relationships between the nodes. The knowledge graph generator 142 stores the resulting dynamic compliance knowledge graph within the knowledge graph database 144.

In a case where one portion or a first portion of the digital compliance file may refer to another portion or a second portion of the digital compliance file, a first node corresponding to the first portion may be connected to a second node corresponding to the second portion of the digital compliance file via an edge.

In another case where the digital compliance file refers to a digital regulation file, the knowledge graph generator 142 may generate another knowledge graph using the output of the NLP algorithm 140, and may connect the knowledge graph of the digital compliance file to the knowledge graph of the digital regulation file. Further, whenever text information in a node of the knowledge graph of the digital regulation file refers to text information in a node of the knowledge graph of the digital regulation file, two nodes are also connected by the knowledge graph generator 142 via an edge. In this way, the knowledge graph may expand by integrating other knowledge graphs based on other digital files, and the knowledge graph database 144 stores the integrated knowledge graph. Thus, the knowledge graph as integrated provides a powerful way to integrate diverse data from separate and disparate sources and further enriches data via the NLP algorithm 140 and the knowledge graph generator 142.

In at least one aspect, the computer system 100 also receives manufacturing status data. The manufacturing status data includes information describing the current status in a manufacturing process for a specific item. For example, the manufacturing status data may include a checklist of steps that have been taken and those that have not yet been taken in a manufacturing compliance process. In additional or alternative aspects, the manufacturing status data may include data from sensors that have been set up in a manufacturing environment. For instance, the sensor data may include image data, pressure data, or any other data sources that are capable of tracking actions taken within a manufacturing environment.

The computer system 100 maps the manufacturing status data to one or more current nodes within the knowledge graph. The one or more current nodes describe a current status of the specific items within the manufacturing process. For instance, the manufacturing data may include information indicating that a particular machine has been set up within the manufacturing environment. In response, the manufacturing compliance module 146 may search the dynamic compliance knowledge graph for one or more current nodes that reference the machine and/or for categories of machines that include the particular machine. The current nodes in this case reference the current status of the manufacturing environment because they reference the machine or type of machine that was recently added.

After identifying the current nodes, the manufacturing compliance module 146 traverses the knowledge graph from the one or more current nodes to one or more target nodes. The one or more target nodes describe a user-provided desired status of manufacturing for the specific items to be compliant with the statutes, regulations, and/or requirements. For example, the user may indicate that a desired level of compliance is the target status. The desired level of compliance may be 100%, 90%, 80%, 75%, 70%, or any other suitable threshold value. As such, the manufacturing compliance module 146 may traverse the dynamic compliance knowledge graph from the one or more current nodes until it reaches target nodes, which nodes indicate that the compliance requirements meet the threshold value. One will appreciate that in some compliance schemes there may be multiple dependent and/or multiple independent pathways to compliance.

Based upon the traversed pathways, the manufacturing compliance module 146 may calculate a metric to indicate a distance between each node and the user-provided desired status. Based on the metric, the manufacturing compliance module 146 may identify one or more target nodes. Thereafter, the manufacturing compliance module 146 may determine based upon the location of the one or more current nodes within the dynamic compliance knowledge graph how many nodes have already been completed and then the manufacturing compliance module 146 may determine how many nodes remain between the one or more current nodes and the one or more target nodes. Based upon these numbers, the manufacturing compliance module 146 may calculate a metric (e.g., a ratio) indicating how far along the user is on the compliance pathway.

For example, the metric may be an L1 norm between two vectors. In other words, each node can be represented as a vector, and the distance between two vectors can be calculated by the following equation:

d=|v₁−v₂|Σᵢ₌₁ⁿ|xᵢ−y_{i|,}

where v₁ is a vector of one node and represented as (x₁, x₂, . . . , xₙ), v₂ is a vector of another node and is represented as (y₁, y₂, . . . , yₙ), and d is the distance.

For another example, the metric may be an L2 norm, which can be calculated by the following equation:

d=|v₁−v₂|=\sqrt{Σᵢ₌₁ⁿ(xᵢ−yᵢ)²}.

In an aspect, the metric may be based on semantic similarity. For example, the semantic similarity between two vectors may be calculated by cosine similarity or the following equation:

$$Cosine Similarity = \frac{{v}_{1} \cdot {v}_{2}}{‖ {v}_{1} ‖ \times ‖ {v}_{2} ‖} ,$$

where v₁·v₂ is a dot product, meaning that v₁·v₂=Σᵢ₌₁ⁿxᵢ×yᵢ, the operation “×” is a scalar multiplication, ∥v₁∥=\sqrt{Σᵢ₌₁ⁿxᵢ²}, and ∥v₂∥=\sqrt{Σᵢ₌₁ⁿyᵢ²}.

As described above, in a case where the metric is a distance, one or more target nodes may be identified by the smallest distance with the user-provided desired status, and in another case where the metric is semantic similarity, the one or more target nodes may be identified by the largest similarity with the user-provided desired status.

One will appreciate, however, that above described metrics are only exemplary and that various other metrics may be used to provide a means to find one or more target nodes based upon the manufacturing status data and the user-provided desired status.

The computer system 100 may include an input device 150, which may be any device by means of which a user may interact with the computer system 100, such as, for example, a mouse, keyboard, voice interface, or touchscreen. The user may use the input device 150 to enter or provide any query to the computer system 100. The query may be the user's current status, user-provided desired status, or any questions related to the knowledge graph.

The NLP algorithm 140 may process the query and the manufacturing compliance module 146 may generate a vector from the query so that the query can be compared with other nodes in the knowledge graph. In this way, the computer system 100 may be able to calculate the distance or semantic similarity between the query and each node and find one or more best node, which match the query.

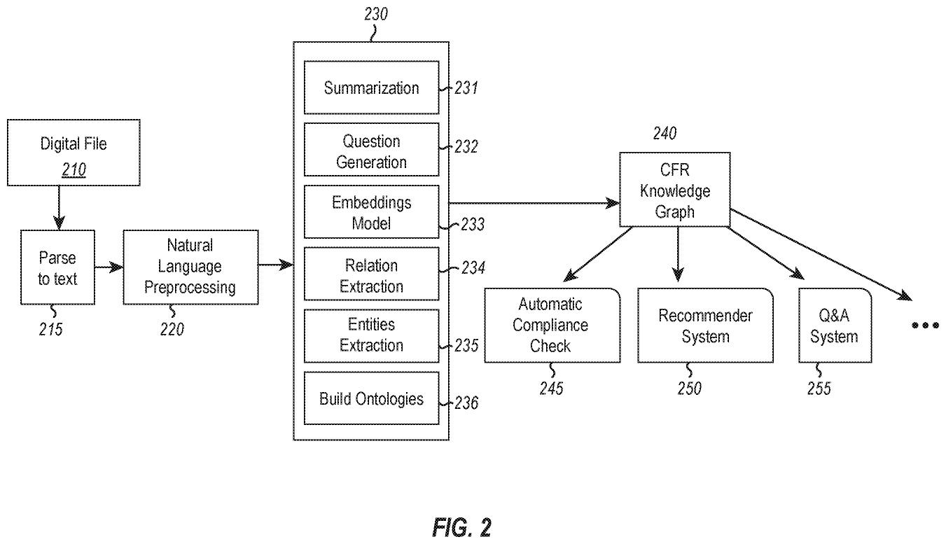

FIG. 2 illustrates a functional flow diagram of a system for implementing a dynamic compliance knowledge graph according to various aspects of the present disclosure. At step 210, a digital file is provided. The digital file may include statutes (e.g., United Stated Code), regulatory codes (e.g., the Code of Federal Regulation), and/or requirements by governmental or civil agencies. The list of the digital files may be added based on new or additional updates in the statutes, codes, and/or requirements. In aspects, the digital file may not be limited to digital text information. Other forms (e.g., offline data, books, magazines, images, analog/digital audios, analog/digital videos etc.) of text information may be ocr-ed or digitized so that digital copies of such may be included in the digital file.

At step 215, the text information may be parsed or broken down to its constituent elements, such as sentences, words, phrases, and linguistic structural elements. At step 220, an NLP algorithm may perform preprocessing over the parsed text. Preprocessing may remove unwanted, irrelevant, or insignificant characters or words. For example, in most cases, “a,” “an,” “the,” “and,” “but,” “is,” “are,” “was,” “were,” “that,” “which,” and the likes do not carry important, relative information, and may be removed during the preprocessing. During the preprocessing, normalization may be also performed by transforming different word forms into their base or root form via stemming or lemmatization. Further, different date forms may also be converted into a standard form. For example, September 3, 2023, Sep. 3, 2023, 3rd Sep. 2023, 9/3/23, 09/03/23, or the likes may be converted into 09-03-2023.

During the preprocessing, acronyms may be expanded to their original form and contracted words may be converted to their original uncontracted phrases. For example, “US” or “U.S.” may be converted to “United States” and “isn't” may be converted to “is not.” Also, all upper case characters may be converted to lower case characters.

When there is a list of items or a table showing relationships between items in rows and items in columns, the list of items may be converted to binary number or decimal numbers via one-hot encoding or nominals. Numbers, whether they are in word format (e.g., one hundred thousand three hundred and three point two three) or in number format (e.g., 100,303.23), may be converted to a pure number format, such as 100303.23. When there are numbers to be compared, such numbers may be converted via z-normalization so that outliers may be easily identified.

This list of preprocessing is provided for explaining purposes only and may include other processes to remove unwanted, irrelevant, or insignificant information, to standardize the textual and numerical information for further processing, and to convert content in the documents to numerical values for further processing and analyses.

Step 230, which includes several steps 231-236, may be performed by the NLP algorithm 140 and/or the knowledge graph generator 142 of FIG. 1. The summarization step 231 may be automatically generating a concise and coherent summary of a longer text while retaining its most important information and meaning. In other words, the summarization step 231 may reduce the length of the text while preserving its key ideas so that the text can be more accessible and easier to understand. Summarization can be applied to various types of textual content, including articles, research papers, news reports, and more.

The question generation step 232 may automatically generate questions based on inputs from a user. When the user inputs questions, which can be understandable by people, the question generation step 232 converts the user-provided questions to revised questions, which can be understandable by the computer system.

The embedding models 233 may convert words into vectors, which include real values in each component thereof. These vectors can be compared with others to calculate a distance or semantic similarity therebetween. These embedding models 233 may include but are not limited to BERT, FastText, GloVe, bag of words, or the likes.

The relation extraction step 234 and the entities extraction step 235 may work together to extract relationships. For example, the entities extraction step 235 involves identifying named entities (e.g., people, organizations, locations, dates, contexts, or the likes) in the text. Once the named entities are identified, the relation extraction step 234 may pair them within the text. Based on these pairs, relationships among named entities can be categorized. For example, marriage, employer-employee relationship, people-location relationship, business-location relationship, products-regulatory relationship, or the likes can be included in the categories of the extracted relationships.

The ontology building step 236 may define the domain of the text based on breath. For example, dental devices may have a broader domain than toothbrushes. Likewise, regulations over the dental devices may have a broader domain than regulations over the toothbrushes. In another example, regulations over healthcare may have a broader domain than regulations over scheduled drugs. The ontology building step 236 may build ontology from a corpus of text so that a hierarchical structure of the knowledge graph can be generated.

In an aspect, these steps 231-236 may be intertwined, interacted, or integrated to generate a dynamic knowledge graph 240. The term “dynamic” in the dynamic knowledge graph 240 may mean that each node in the knowledge graph 240 may be connected to each other based on different ontological approaches. Further, the knowledge graph 240 may be dynamically updated according to updates of and new provisions to the corpus of text so that the structure of the knowledge graph 240 may be drastically changed. In a case when compliance is involved, the steps 231-236 generate a dynamic compliance knowledge graph.

Steps 245, 250, and 255 may be performed by the manufacturing compliance module 146 of FIG. 1. The manufacturing compliance module 146 may automatically perform compliance check. Based on the initial status, the current status, and the desired status received from a user, the manufacturing compliance module 146 may check how close the current status is from the desired status according to the knowledge graph 240, and also check whether the current status follows an optimal compliance path from the initial status and the desired status. The current status may be automatically obtained from one or more sensors.

In a case when the current status is deviated from the optimal compliance path, the manufacturing compliance module 146 may provide recommendations for steps to get back to the optimal compliance path at recommendation step 250. In another aspect, the manufacturing compliance module 146 may also generate an optimal compliance path when the initial or current status and the desired status are provided. The optimal compliance path may be a path from an initial node corresponding to the initial or current status to a desired node corresponding to the desired status within the dynamic knowledge graph 240.

At question and answer (Q&A) step 255, the user provides questions to the computer system 100, and the computer system 100 may answer the questions based on the dynamic knowledge graph 240. Specifically, the questions may be converted to a vector, and the manufacturing compliance module 146 may output one or more target nodes, of which distance is the smallest from the converted vector or of which sematic similarity is the largest with the converted vector.

Functions of the computer system 100 are not limited to the above-described steps but can include other functions, steps, and methods to generate the dynamic knowledge graph 240, find the optimal compliance path, and check whether the current status follows the optimal compliance path, as persons having skill in the art would readily appreciate.

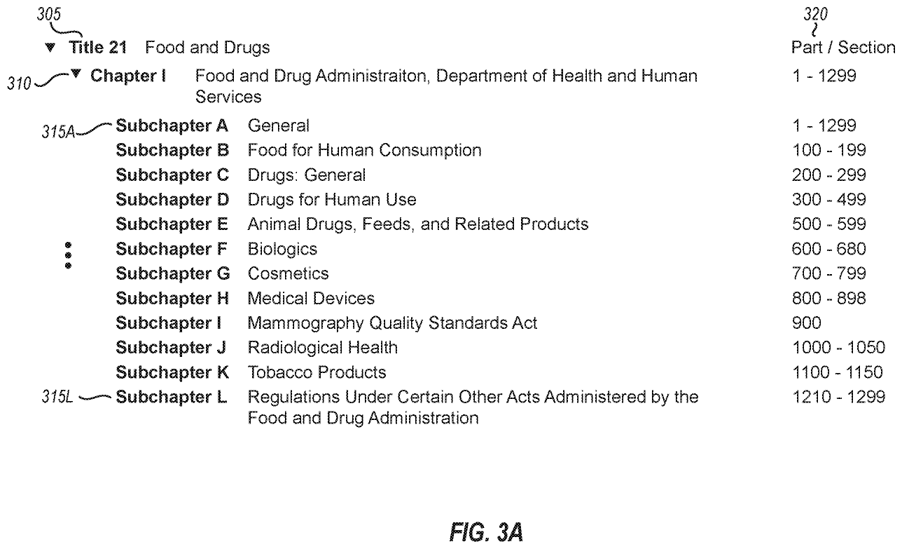

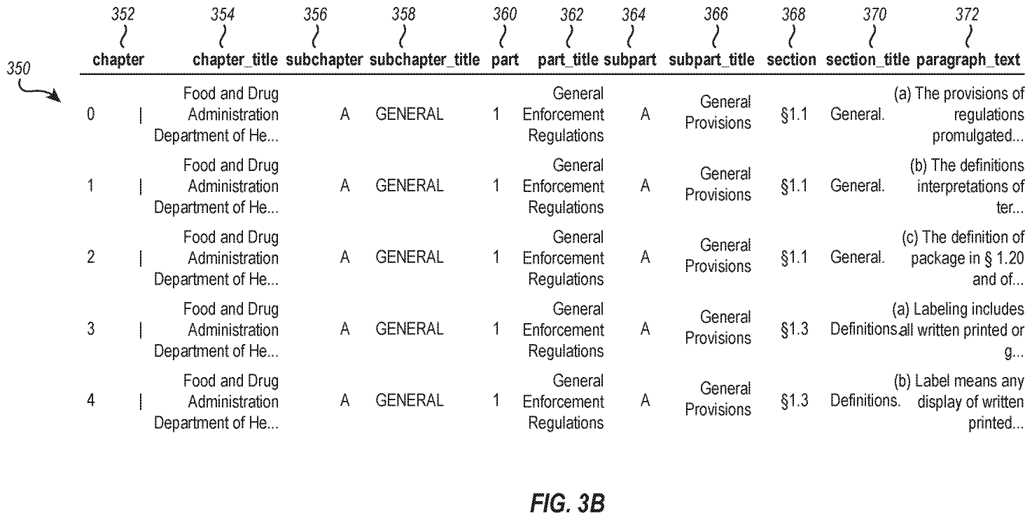

FIG. 3A illustrates a table of content of one section of the Code of Federal Regulations (CFR) as an example of a corpus of text. Title 21 as referenced by reference numeral 305 is related to “Food and Drugs” and includes many chapters. Each chapter includes many subchapters. For example, Chapter 1 as referenced by reference numeral 310 is “Food and Drug Administration, Department of Health and Human Services” and includes 1,299 parts or sections as indicated by reference numeral 320.

Chapter 1 also includes Subchapters A-L as referenced by reference numerals 315a-315l. For example, Subchapter C is related to “Drugs: General” and includes 100 parts or sections starting from 200th part or section to 299th part or section among the 1,299 parts or sections, and Subchapter H is related to “Medical Devices” and includes 99 parts or sections starting from 800th part or section to 898th part or section among the 1,299 parts or sections.

Each part may include subparts. For example, Part 872 is related to “Dental Devices” and includes Subparts A-G. Subpart G is related to “Miscellaneous Devices” and includes sections 872.6010-872.6890. Among those sections, manual toothbrush is in section 872.6855 and powered toothbrush is in section 872.6865. For example, section 872.6855(b) is classification and states “Class I (general controls). The device is exempt from the premarket notification procedures in subpart E of part 807 of this chapter subject to the limitations in § 872.9. If the device is not labeled or otherwise represented as sterile, it is exempt from the current good manufacturing practice requirements of the quality system regulation in part 820 of this chapter, with the exception of § 820.180, with respect to general requirements concerning records, and § 820.198, with respect to complaint files.” As quoted here, it is noted that section 872.6855(b) refers to subpart E of part 807, § 872.9, § 820.180, and § 820.198.

As described above, the CFR is organized hierarchically from the top level (i.e., the Title) to the bottom level (e.g., parts, subparts, and sections.). However, as quoted in section 872.6855(b), each chapter, subchapter, part, subpart, and/or section can refer to another chapter, subchapter, part, subpart, and/or section in the CFR. As such, even though the CFR is structured hierarchically, contents thereof are intertwined to each other. This is why users take time and effort to be compliant with the CFR. For example, if the user manufactures manual toothbrushes, the user has to look at section 872.6855(b) together with subpart E of part 807, § 872.9, § 820.180, and § 820.198. It does not end with these portions because subpart E of part 807, § 872.9, § 820.180, and § 820.198 may refer to other chapters, subchapters, parts, subparts, and/or sections.

Further, the CFR can refer to not only chapters, subchapters, parts, subparts, and/or sections therewithin but also portions of the United Stated Code. Furthermore, the compliance does not end there but the user also has to follow requirements prescribed by other related regulatory governmental and/or civil agencies. Since knowledge graphs are suited for regulated industries and regulators, they can enable smart integration of large volumes of heterogeneous corpora of text leading to significant time, resource and cost savings for compliance checking and monitoring.

FIG. 3B illustrates exemplary representations of nodes of a knowledge graph after processing the CFR according to various aspects of the present disclosure. Each node of the knowledge graph may include metadata 350, which includes chapter 352, capture title 354, subchapter 356, subchapter title 358, part 360, part title 362, subpart 364, subpart title 366, section 368, section title 370, and paragraph text 372. This list in the metadata 350 may vary depending on the text information such as CFR, USC, or any other regulations, laws, codes, or protocols. In this case, the list of the metadata 350 may include the hierarchical structure of the CFR. For example, in the bottom metadata 350, the corresponding node is related to § 1.3 with title “Definition,” which includes “(b) Label means any display of written printed . . . ,” of Subpart A with title “General Provision” of Part 1 with title “GENERAL ENFORCEMENT REGULATIONS” of Subchapter A with title “GENERAL” of Chapter 4 with title “FOOD AND DRUG ADMINISTRATION DEPARTMENT OF HE . . . .” Thus, based on the metadata 350, the computer system may be able to trace back to every level of hierarchy to which each node belongs.

Textual information in the metadata 350 may be summarized from or a carbon copy of the corresponding portion of the CFR. Based on the textual information in each node, entities may be extracted at the step 235 of FIG. 2, and relationships with other portions of the CFR may be established by the relation extraction step 234 of FIG. 2. Detailed description of such is followed below.

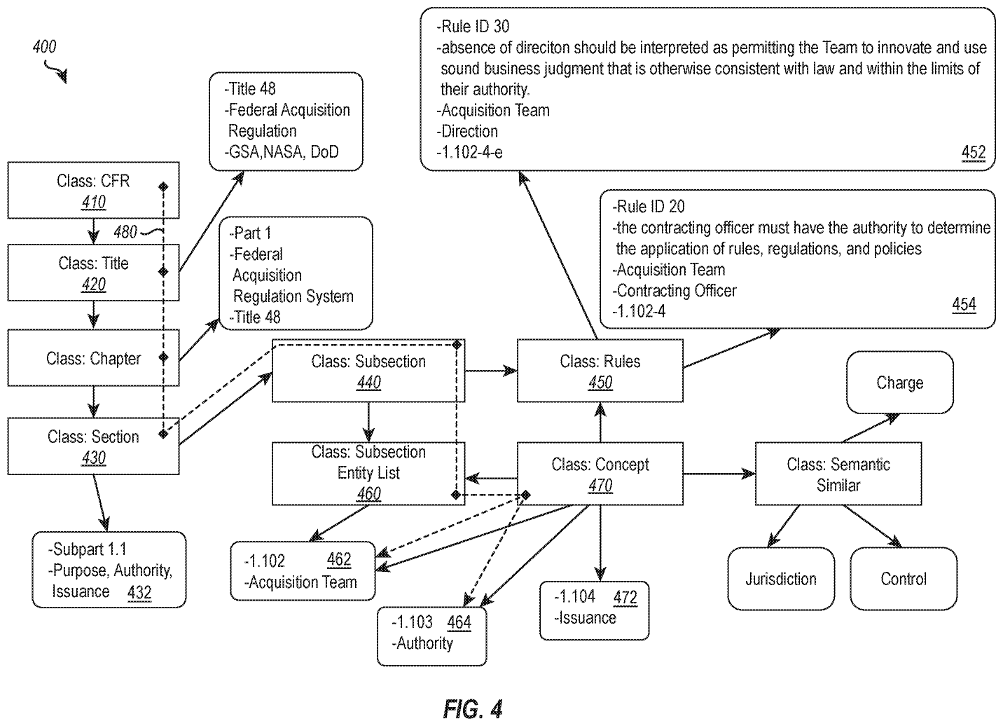

FIG. 4 illustrates a simplified knowledge graph 400 generated from the Code of Federal Regulations according to various aspects of the present disclosure. The top node 410 of the knowledge graph 400 is classified as the CFR, and the next node 420 is classified as Title. The Title node 420 has a terminal node 422 with text information of “Title 48,” “Federal Acquisition Regulation,” and “GSA, NASA, DoD.”

Fourth level node 430 is classified as Section and has terminal node 432 with text information of “subpart 1.1” and “Purpose, Authority, Insurance.” Fifth level node 440 is classified as SubSection and includes two sixth level nodes: one 460 is classified as SubSection Entity List and the other one 450 is classified as Rules. It is noted that the computer system 100 may extract entities from the text information of SubSection node 440 and generate the entity list node 460, which might not exist in the CFR as a separate SubSection. The entity list node 460 includes two terminal nodes: one node 462 is related to § 1.102 Acquisition Team and the other node 464 is related to § 1.103 Authority. The knowledge graph 400 also includes node 470 as classified as Concept, which might not exist as a separate portion in the CFR. The concept node 470 includes a terminal node 472 of “§ 1.104 Issuance.”

As the concept node 470 is connected to the nodes 462, 464, and 472, the computer system may establish relationships therebetween even though the nodes 462 and 644 are under the entity list node 460. Likewise, the entity list node 460 is also connected to the node 472 based on ontological relationships built by the computer system.

When the current status of the user is identified as being at the concept node 470 and a user-provided desired status may be entered or have been entered, the computer system can find three terminal nodes 432, 462, and 464 as semantically or metrically closest with the user-provided desired status. However, based on the metadata of the current node 470, the terminal node 432 is further distant from the current node 470 or the terminal nodes 462 and 464. Thus, the terminal node 432 is removed and the terminal nodes 462 and 464 are selected as the target states or nodes. In other words, the target nodes may be not based solely on the desired status but may be based on the desired status and the current status. In this sense, the hierarchical structure saved in the metadata of the current and desired statuses is considered in finding one desired target node.

When more than one target node is requested, target nodes other than the desired target node may be considered. Particularly, the metric is also calculated between the target nodes and the desired target node. When the metric does not meet a predetermined threshold, such target nodes may be removed, and the other target nodes, which meet the predetermined threshold, are considered as requested target nodes. This process may be performed by retrieval augmented generation. The desired target node may be used as a guardrail to remove unrelated target nodes so that target nodes unrelated to the desired target node are not provided to the user.

In an aspect, the computer system may calculate a level (e.g., 73%) of compliance based on the current node and one or more target nodes.

In another aspect, when the user has not provided a current status but provided a desired status, the computer system may find the target nodes 462 and 464 and generate one or more optimum compliance paths 480 by tracing back to the top node 410 based on the metadata save in the target nodes 462 and 464. Based on the optimum compliance path 480, the user may be able to follow the compliance path to be compliant with the CFR.

In a case where corpora of text other than the CFR are provided, the computer system may integrate the corresponding knowledge graphs into the knowledge graph based on the CFR. Then, the computer system may generate a new/updated optimum compliance path based on the integrated knowledge graph. In this way, the user can follow the optimum compliance path in order to be compliant with all the corpora of text including statutes, regulations, and/or requirements.

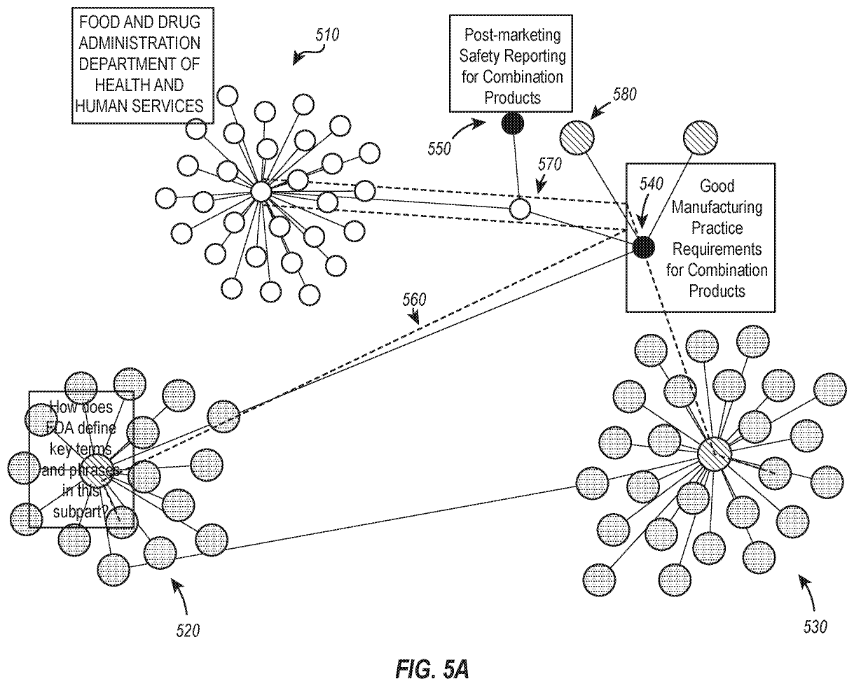

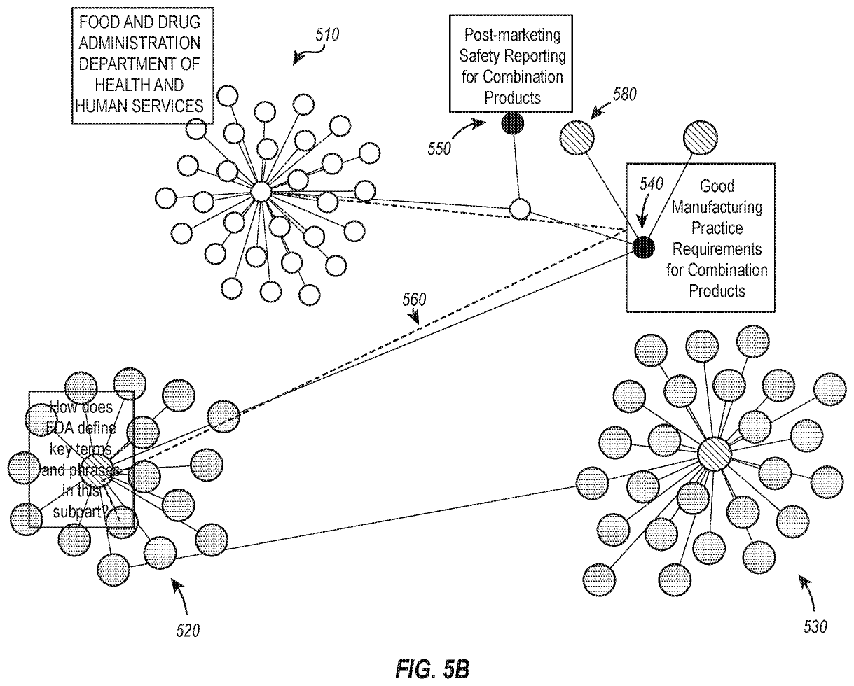

FIG. 5A illustrates another simplified dynamic compliance knowledge graph 500 with two potential compliance paths 560 and 570 according to various aspects of the present disclosure. Though, it should be appreciated that the dynamic compliance knowledge graph 500 is only shown for the exemplary purposes. The dynamic compliance knowledge graph 500 may have various distinct groups of nodes 510, 520, and 530. In this disclosure, the distinct groups of nodes mean a group of nodes, which are close to each other compared to other nodes in another group of nodes. As shown in FIG. 5A, one node of the group of nodes 520 is connected to the group of nodes 530. Nevertheless, distance wise or semantical similarity-wise, the node of the group of nodes 520 is a node in the group of nodes 520 rather than in the group of nodes 530.

In one scenario, a user may ask the computer system a question about how the use can comply with current good manufacturing practice requirements for a co-packaged or single-entity combination product. The computer system may find two potential target nodes 540 and 550, which are close to a vector derived from the question. One potential target node 540 is related to “Good Manufacturing Practice Requirements for Combination Products” and the other potential target node 550 is related to “Post-marketing Safety Reporting for Combination Products.”

Based on these two potential target nodes 540 and 550, the computer system may be able to generate two respective optimum compliance paths 560 and 570. The compliance path 560 is a path from one node in the group of nodes 520 to a node in the group of nodes 510 via the target node 540, and the other compliance path 570 is a path from a node in the group of nodes 510 to a node in the group of nodes 530 via the target node 540. At this stage, it is not clear which compliance path would be optimum or desired.

The user may enter the current status to the computer system. At this moment, the computer system may be able to specify a current node corresponding to the current status. FIG. 5B illustrates the current node 580 together with the dynamic compliance knowledge graph 500 and one compliance path 560 according to various aspects of the present disclosure. Based on the semantic similarity calculation, the potential target node 540 is selected as the target node. In other words, the current node 580 is semantically closer to than the potential target node 550.

The removal of the potential target node 550 leads to removal of the potential compliance path 570. Differently put, the compliance path 560 may be determined based on the current status of the user and the user-provided desired status.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

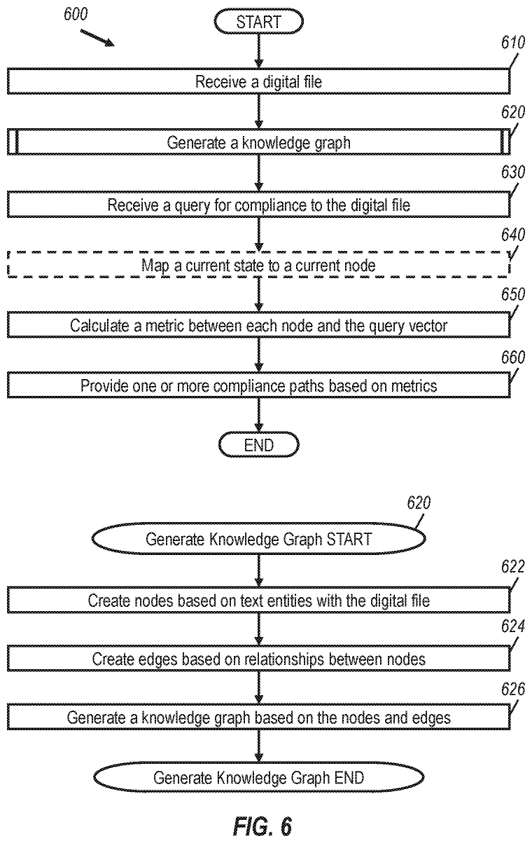

FIG. 6 illustrates a flowchart of steps of a method 600 for implementing a dynamic compliance knowledge graph according to various aspects of the present disclosure. The method 600 may include a step 610 of receiving a digital file, which may include digital compliance file, digital regulation file governing one or more compliance processes for manufacturing specific items, and/or any requirements prescribed by governmental or civil agencies. The structure of the digital file may be in a hierarchical order, meaning that the content thereof is organized from the top level to the bottom level.

The method 600 may include a step 620 of generating a knowledge graph from the corpus of text within the digital file. In aspects, prior to generating the knowledge graph, the corpus of text may be parsed and preprocessed so as to be ready for natural language processing. Parsing and preprocessing may include removing unwanted, irrelevant, or insignificant characters or words and transforming different word forms into their base or root form via stemming or lemmatization.

The step 620 may include several separate steps 622-626. First, step 622 is performed by creating nodes based on one or more text entities within the digital file. In an aspect, each node may include metadata, which identifies every hierarchical level to which each node belongs. Thus, based on the metadata, the top level of the digital file can be traced back from the node in the knowledge graph. In another aspect, each node includes text information of a corresponding portion of the digital file.

The step 624 may be performed by identifying relationships between the nodes within the digital file and creating edges based on the relationships between nodes. In an aspect, the step 624 may be further performed by identifying entities in the nodes within the digital file. Such entities may also provide relationships therebetween, thereby creating nodes and relationships between nodes. In another aspect, the step 624 may build ontology within the corpus of text in the digital file. The ontology may define domains within the corpus of text based on breath. For example, dental devices, which are included in Part 872 in Subchapter H “Medical Devices” in Chapter I “Food And Drug Administration, Department Of Health And Human Services” in Title 21 “Food and Drugs” in the CFR, may have a broader domain than manual or powered toothbrushes, which are included in § 872.6855 and § 872.6865, respectively, in Subpart G “Miscellaneous Devices” in Part 872. “Dental Device.” Likewise, regulations over the medical devices may have a broader domain than regulations over the dental devices. In another example, regulations over healthcare may have a broader domain than regulations over scheduled drugs. With results from the ontology building, the edges may be created in step 624. Edge creation is not limited to relationship extraction or ontology building but can be performed by any other means readily available to a person of skill in the art.

The step 626 may be performed by generating a knowledge graph by connecting the nodes and edges based on the relationships and/or ontology.

Now returning back to the method 600, a user may enter a query for compliance with the digital file and a step 630 is performed by receiving the query. In a case where the query includes a current status of the user in manufacturing specific items, the method 600 optionally includes a step 640 of mapping the current status of the user to a current node. Specifically, the current status may be converted into a current status vector so that the current status vector may be compared with vectors of the nodes. A metric may be used in the comparison. The metric may be a distance or semantic similarity between the current status vector and each node of the knowledge graph. When one node is found to be most close or semantically similar to the current status vector, the found node is determined to be the current node. In other words, step 640 is performed by mapping the current status of the user to the current node.

In addition, the method 600 may include a step 650 of traversing every node in the knowledge graph to find one or more target nodes. To traverse the knowledge graph, the query has to be converted into a query vector, which can be comparable with vectors of the nodes of the knowledge graph. The query may describe a user-provided desired status of manufacturing for the specific items. By calculating a metric between the query vector and a vector of each node, step 650 may be able to find one or more target nodes, of which metrics from the query vector provide the smallest distance or the highest semantical similarity.

The method 600 may also include a step 660 of providing one or more compliance paths based on the one or more target nodes. Since each node includes metadata specifying the hierarchical order of the digital file, when one or more target nodes are found, a compliance path from the top node of the knowledge graph, which corresponds to the top level of the digital file, to a target node can be identified.

In an aspect, when the query includes the current status of the user, one or more target nodes may be also compared with the current node. The closest or most semantically similar node or the desired target node may be chosen to provide an optimum compliance path between the current node and the target node.

In another aspect, the one or more target nodes other than the desired target node may be compared with the desired target node. When the distance is greater than a predetermined threshold or the semantic similarity is greater than another predetermined threshold, such target nodes may also be chosen to provide the corresponding compliance paths. Otherwise, such target nodes are not considered.

In still another aspect, when a user asks to find “n” number of compliance paths, the predetermined threshold may be adjusted to increase or decrease the number of target nodes meeting the predetermined threshold.

Further, the methods may be practiced by a computer system including one or more processors and computer-readable media such as computer memory. In particular, the computer memory may store computer-executable instructions that when executed by one or more processors cause various functions to be performed, such as the acts recited in the aspects.

Computing system functionality may be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to receive application data quickly and efficiently from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that may be provisioned and released with reduced management effort or service provider interaction. A cloud model may be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available.

Examples of software user interfaces include graphical user interfaces, text command line based user interface, function key or hot key user interfaces, and the like.

Disclosed aspects may include or utilize a special purpose or general-purpose computer including computer hardware, as discussed in greater detail below. Disclosed aspects also include physical and other computer-readable media for carrying or storing computer-executable instructions and/or data structures. Such computer-readable media may be any available media that may be accessed by a general purpose or special purpose computer system. Computer-readable media that store computer-executable instructions are physical storage media. Computer-readable media that carry computer-executable instructions are transmission media. Thus, by way of example, and not limitation, aspects of the invention may include at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which may be used to store desired program code means in the form of computer-executable instructions or data structures and which may be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media may include a network and/or data links which may be used to carry program code in the form of computer-executable instructions or data structures and which may be accessed by a general purpose or special purpose computer. Combinations of the above are also included within the scope of computer-readable media.

Further, upon reaching various computer system components, program code means in the form of computer-executable instructions or data structures may be transferred automatically from transmission computer-readable media to physical computer-readable storage media (or vice versa). For example, computer-executable instructions or data structures received over a network or data link may be buffered in RAM within a network interface module (e.g., a “NIC”), and then eventually transferred to computer system RAM and/or to less volatile computer-readable physical storage media at a computer system. Thus, computer-readable physical storage media may be included in computer system components that also (or even primarily) utilize transmission media.

Computer-executable instructions include, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein may be performed, at least in part, by one or more hardware logic components. For example, and without limitation, illustrative types of hardware logic components that may be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In various aspects, the techniques described herein relate to a computer system for implementing a dynamic compliance knowledge graph including: one or more processors; and one or more computer-readable media having stored thereon executable instructions that when executed by the one or more processors configure the computer system to: receive a digital file including a compliance file, which includes one or more levels of compliance processes in a hierarchical order; generate a knowledge graph from text within the digital file by: creating nodes based on one or more text entities within the digital file; creating edges based on relationships between the nodes within the digital file, and generating the knowledge graph based on the nodes and the edges; receive a query regarding compliance to the digital file; calculate a metric between each node to a query vector of the query; and provide one or more compliance paths to one or more target nodes based on metrics.

In various aspects, the techniques described herein relate to a computer system, wherein each node of the knowledge graph includes metadata, which identifies every hierarchical level to which each node belongs.

In various aspects, the techniques described herein relate to a computer system, wherein each node of the knowledge graph includes text information of a corresponding portion of the digital file.

In various aspects, the techniques described herein relate to a computer system, wherein each node is represented as a vector, and any two nodes may be compared with each other to calculate the metric therebetween.

In various aspects, the techniques described herein relate to a computer system, wherein the instructions, when executed by the one or more processors, further configure the computer system to: embed the query into the query vector, wherein the query vector is compared to a vector of each node to calculate a respective metric therebetween.

In various aspects, the techniques described herein relate to a computer system, wherein providing the one or more compliance paths includes finding a first target node based on highest semantic similarity.

In various aspects, the techniques described herein relate to a computer system, wherein the one or more compliance paths share a majority of a compliance path to the first target node.

In various aspects, the techniques described herein relate to a computer system, wherein a metric between each of the one or more target node and the compliance path is less than a threshold.

In various aspects, the techniques described herein relate to a computer system, wherein the digital file includes a regulation file including one or more levels of regulations in a hierarchical order.

In various aspects, the techniques described herein relate to a computer system, wherein a portion of nodes of the knowledge graph related to the compliance file is connected to a portion of nodes of a knowledge graph related to the regulation file via edges.

In various aspects, the techniques described herein relate to a method for implementing a compliance knowledge graph, the method including: receiving a digital file including a compliance file, which includes one or more levels of compliance processes in a hierarchical order; generating a knowledge graph from text within the digital file by: creating nodes based on one or more text entities within the digital file; creating edges based on relationships between the nodes within the digital file; and generating the knowledge graph based on the nodes and the edges; receiving a query regarding compliance to the digital file; calculating a metric between each node to a query vector of the query; and providing one or more compliance paths to one or more target nodes based on metrics.

In various aspects, the techniques described herein relate to a method, wherein each node of the knowledge graph includes metadata, which identifies every hierarchical level to which each node belongs.

In various aspects, the techniques described herein relate to a method, wherein each node of the knowledge graph includes text information of a corresponding portion of the digital file.

In various aspects, the techniques described herein relate to a method, further including: embedding the query into the query vector, wherein the query vector is compared to a vector of each node to calculate a respective metric therebetween.

In various aspects, the techniques described herein relate to a method, wherein providing the one or more compliance paths includes finding a first target node based on highest semantic similarity.

In various aspects, the techniques described herein relate to a method, wherein the one or more compliance paths share a majority of a compliance path to the first target node.

In various aspects, the techniques described herein relate to a method, wherein a metric between each of the one or more target node and compliance path is less than a threshold.

In various aspects, the techniques described herein relate to a method, wherein the digital file includes a regulation file including one or more levels of regulations in a hierarchical order.

In various aspects, the techniques described herein relate to a method, wherein a portion of nodes of the knowledge graph related to the compliance file is connected to a portion of nodes of a knowledge graph related to the regulation file via edges.

In various aspects, the techniques described herein relate to a nontransitory computer readable medium including computer executable instructions that, when executed by a computer, cause the computer to perform a method for implementing a compliance knowledge graph, the method including: receiving a digital file including a compliance file, which includes one or more levels of compliance processes in a hierarchical order; generating a knowledge graph from text within the digital file by: creating nodes based on one or more text entities within the digital file; creating edges based on relationships between the nodes within the digital file; and generating the knowledge graph based on the nodes and the edges; receiving a query regarding compliance to the digital file; calculating a metric between each node to a query vector of the query; and providing one or more compliance paths to one or more target nodes based on metrics.

The present invention may be embodied in other specific forms without departing from its spirit or characteristics. The described aspects are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for implementing a dynamic compliance knowledge graph comprising:
one or more processors; and
one or more computer-readable media having stored thereon executable instructions that when executed by the one or more processors configure the computer system to:
receive a digital file including a compliance file, which includes one or more levels of compliance processes in a hierarchical order;
generate a knowledge graph from text within the digital file by:
creating nodes based on one or more text entities within the digital file;
creating edges based on relationships between the nodes within the digital file, and
generating the knowledge graph based on the nodes and the edges;
receive a query regarding compliance to the digital file;
calculate a metric between each node to a query vector of the query; and
provide one or more compliance paths to one or more target nodes based on metrics.

2. The computer system according to claim 1, wherein each node of the knowledge graph includes metadata, which identifies every hierarchical level to which each node belongs.

3. The computer system according to claim 1, wherein each node of the knowledge graph includes text information of a corresponding portion of the digital file.

4. The computer system according to claim 1, wherein each node is represented as a vector, and
any two nodes may be compared with each other to calculate the metric therebetween.

5. The computer system according to claim 1, wherein the instructions, when executed by the one or more processors, further configure the computer system to:
embed the query into the query vector, wherein
the query vector is compared to a vector of each node to calculate a respective metric therebetween.

6. The computer system according to claim 1, wherein providing the one or more compliance paths includes finding a first target node based on highest semantic similarity.

7. The computer system according to claim 6, wherein the one or more compliance paths share a majority of a compliance path to the first target node.

8. The computer system according to claim 7, wherein a metric between each of the one or more target nodes and the one or more compliance paths is less than a threshold.

9. The computer system according to claim 1, wherein the digital file includes a regulation file including one or more levels of regulations in a hierarchical order.

10. The computer system according to claim 9, wherein a portion of nodes of the knowledge graph related to the compliance file is connected to a portion of nodes of a knowledge graph related to the regulation file via edges.

11. A method for implementing a compliance knowledge graph, the method comprising:
receiving a digital file including a compliance file, which includes one or more levels of compliance processes in a hierarchical order;
generating a knowledge graph from text within the digital file by:
creating nodes based on one or more text entities within the digital file;
creating edges based on relationships between the nodes within the digital file; and
generating the knowledge graph based on the nodes and the edges;
receiving a query regarding compliance to the digital file;
calculating a metric between each node to a query vector of the query; and
providing one or more compliance paths to one or more target nodes based on metrics.

12. The method according to claim 11, wherein each node of the knowledge graph includes metadata, which identifies every hierarchical level to which each node belongs.

13. The method according to claim 11, wherein each node of the knowledge graph includes text information of a corresponding portion of the digital file.

14. The method according to claim 11, further comprising:
embedding the query into the query vector, wherein
the query vector is compared to a vector of each node to calculate a respective metric therebetween.

15. The method according to claim 11, wherein providing the one or more compliance paths includes finding a first target node based on highest semantic similarity.

16. The method according to claim 15, wherein the one or more compliance paths share a majority of a compliance path to the first target node.

17. The method according to claim 16, wherein a metric between each of the one or more target nodes and the one or more compliance paths is less than a threshold.

18. The method according to claim 11, wherein the digital file includes a regulation file including one or more levels of regulations in a hierarchical order.

19. The method according to claim 18, wherein a portion of nodes of the knowledge graph related to the compliance file is connected to a portion of nodes of a knowledge graph related to the regulation file via edges.

20. A nontransitory computer readable medium including computer executable instructions that, when executed by a computer, cause the computer to perform a method for implementing a compliance knowledge graph, the method comprising:
receiving a digital file including a compliance file, which includes one or more levels of compliance processes in a hierarchical order;
generating a knowledge graph from text within the digital file by:
creating nodes based on one or more text entities within the digital file;
creating edges based on relationships between the nodes within the digital file; and
generating the knowledge graph based on the nodes and the edges;
receiving a query regarding compliance to the digital file;
calculating a metric between each node to a query vector of the query; and
providing one or more compliance paths to one or more target nodes based on metrics.
